(19) United States
(12) Patent Application Publication
(10) Pub. No.: US 2013/0280681 A1
(43) Pub. Date: Oct. 24, 2013

(54) SYSTEM AND METHOD FOR MONITORING FOOD CONSUMPTION

(71) Applicants: Vivek Narayan, Cuyahoga Falls, OH (US); Shweta Singh, Strongsville, OH (US)

(72) Inventors: Vivek Narayan, Cuyahoga Falls, OH (US); Shweta Singh, Strongsville, OH (US)

(21) Appl. No.: 13/839,121

(22) Filed: Mar. 15, 2013

Related U.S. Application Data
(60) Provisional application No. 61/625,031, filed on Apr. 16, 2012.

(51) Int. Cl. G09B 19/00

(52) U.S. Cl. CPC G09B 19/0092
USPC 434/127

(57) ABSTRACT

Systems and methods that employ computer processors and computer executable instructions to identifying state information of a user; and suggest personalized food choices based on the user's dietary history at point of purchase or point of decision making to encourage healthy food choices.

### PRIORITY CLAIM

This patent application claims the benefit of priority to U.S. Provisional Patent Application Ser. No. 61/625,031, filed Apr. 16, 2012, and entitled SYSTEM AND METHOD FOR MONITORING FOOD CONSUMPTION. The entirety of this provisional patent application is hereby incorporated herein by reference.

### TECHNICAL FIELD

This disclosure relates to system(s) and method(s) for monitoring and regulating food consumption.

### BRIEF DESCRIPTION OF THE DRAWINGS

FIG. 1 illustrates a block diagram representing an exemplary non-limiting operating environment in which the various embodiments can be implemented.

FIG. 2 illustrates a block diagram representing an exemplary non-limiting networked computing environment in which the various embodiments can be implemented. Appendix discloses example details in connection with the innovation described herein. This appendix forms part of the specification.

### DETAILED DESCRIPTION

### Overview

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of this disclosure may be practiced without these specific details, or with other methods, components, materials, etc. In other instances, well-known structures and devices are shown in block diagram form to facilitate describing this disclosure.

It is to be appreciated that in accordance with one or more implementations described in this disclosure, users can opt-out of providing personal information, demographic information, location information, proprietary information, sensitive information, or the like in connection with data gathering aspects. Moreover, one or more implementations described herein can provide for anonymizing collected, received, or transmitted data.

In embodiment relates to a web-based application that individuals can employ to select and track what they eat, wherever they are, based on their individual dietary concerns and needs. The web-based application suggests personalized food choices based on the user's dietary history at the point of purchase or point of decision making to encourage healthy food choices. The web-based application can provide one or more of the following services:

(1) Location-based contextual information regarding food choices based on customized dietary constraints and food preferences, e.g., utilizing geolocation for grocery stores, restaurants, and recommending meals based on previous inputs and dietary needs;

(2) Easy to use Nutritional Indices providing a single data point with which to decipher nutritional information—making it easier for users to understand nutritional data and facilitate food making decisions. Simple decisions are easier to make and result in less buyer's remorse and feelings of guilt associated with poor decision making. The nutritional information can be geographically circumscribed and presented to the user on his/her data enabled device (e.g., cell phone, tablet computer, desktop computer, personal data assistant (PDA), smart phone, . . . ) to allow the user to make smart eating or purchasing choices at point of purchase based on the user's personal eating behavior and preferences. The information can be presented to the user in an easy to assimilate single data point based on the concept of nutrient density;

(3) Customized interventions which remind users to avoid eating certain types of food based on location, health history and food preferences; and/or

(4) Goal-oriented tool in the form of a ‘virtual avatar’—(Monjee/iMonjee)-which responds by changes to its appearance, energy level etc. . . . to food eaten by the user. The Monjee/iMonjee also represents the user in the social network/virtual world and changes its physical appearance and energy levels based on what food has been eaten by the user and his/her current energy expenditure. Based on the exercise being performed, GorMonjee can also recommend foods specific to the user and specific to the mode of exercise being performed. Each food choice, once chosen, can potentially become advertising revenue by virtue of CTR or Coupon based monetization avenues.

More particularly, in connection with the above noted aspects, below are example implementation aspects.

Easy to Use Nutritional Indices Providing a Single Data Point with which to Decipher Nutritional Information

Score (e.g., a Gormonjee Score)
For example, systems and/method described herein can aggregate individual meals, days of meals, weeks, years, location, populations or user selected timespan of aggregation.
Let C be the amount of total calories to be consumed per day
   Cm, Default Value for Males=2000
   Cf, Default Value for Females=1800
Let Pi be the Proportion of calories consumed per i (ie per meal per day) where Pi, ii, iii etc. . . . =C
   Default Value for # of P=3
      3 meals a day—Pi, ii, iii
      default value of Pi=40%
      default value of Pii=30%
      default value of Piii=30%
Let MACi be the Proportion of Macronutrients consumed per day and where
   MACc=the percentage of Carbohydrates
   MACf=the percentage of Fat
   MACp=the percentage of Proteins
Let Mfb=weight in grams of fiber per day
Let MICmi be the weight in grams of micronutrients (minerals) to be consumed per day
   Where MICmi, ii, iii . . . is the weight of Calcium, Iron, Magnesium etc. . . . (USDA Db has a standard list of micronutrients)
Let MICvi be the weight in grams of micronutrients (vitamins) to be consumed per day
   Where MICvi, ii, iii . . . is the weight of Vit A, D, Folate etc. . . . (USDA Db has a standard list of vitamins)

Calculation of GorMonjee Score

The GorMonjee Score is a composite (Average) score of Vitamins, Minerals and Macronutrients (Categories) . . . whereby the ratio of ‘requirements’ per meal and actual nutritional quality of food consumed per that meal is expressed as a percentage. The intermediate Scores for each category is the average of its components, where each nutrient can only be expressed to a maximum of 100% despite the fact that the ratio may actually be 250% as an example. The deficits/surplaces are used to calculate subsequent scores.

The requirements of the meal are calculated essentially based on Pi, ii, iii by multiplying the daily requirements of Macronutrients and Micronutrients—both minerals and vitamins—by the Proportion of food to be consumed per meal.

eg Calorie Requirement for Breakfast (Pi) is 40%—by default hence Calorie requirements for breakfast would be (in the case of males) 2000×0.40=800 Calories

Similarly Calcium Requirements for breakfast would be 1000 mg×0.4=400 mg of calcium

Table 1.1 describes a sample calculation of a “Category Micronutrient” calculation. In this case, Minerals.

To note—Because the Score is designed to be contextual, no single nutrient is allowed to influence the overall score more than its average weighted value. Ie calcium can only account for 1/9^{th} of the category score and hence values over 100% are ‘normalized’ to a 100%. In the example below, the total meal, delivers over 500% of the Iron requirements for that meal and hence could be considered a very good source of Iron. However, to calculate the ‘score’ it would still account for only 1/9^{th} of the score when calculating the GorMonjee Score for the meal. However, the absolute value (content of nutrients) would be used to calculate the GorMonjee Score for the ‘Day’ or any time period in question. Hence, the creation of completely contextual scores depending on the granularity of information required by the user. In this particular case, the category score for minerals during breakfast was close to 80%. Similarly, the score for Vitamins and Macronutrients is approximately 96% and 66% respectively. The GorMonjee Score is simply an average of the category scores; in this case about 80 percent.

TABLE 1.1

| | | | Homemade food | | | | | |
|---|---|---|---|---|---|---|---|---|
| | | | | | 3 | | 5 | |
| | | | 1 | | Glass | 4 | Ratio of | |
| | | BF | Honey | 2 | of | Total | Food to | 6 |
| | | Require- | Nut | Banana | Orange | Break | Require- | Normal- |
| | Total | ments | Cheerios | Raw | Juice | Fast | ments | ized |
| Calories | | 800 | 393 | 89 | 45 | 527 | 66% | 66% |
| Micro - nutrients | | | | | | | | |
| Minerals (mg) | | | | | | | | |
| Calcium mg | 1000 | 400 | 357.00 | 5.00 | 12.00 | 374 | 94% | 94% |
| Iron mg | 8 | 3.2 | 16.07 | 0.26 | 0.17 | 16.5 | 516% | 100% |
| Magnesium mg | 420 | 168 | 86.00 | 27.00 | 9.00 | 122 | 73% | 73% |
| Phosphorous mg | 700 | 280 | 286.00 | 22.00 | 11.00 | 319 | 114% | 100% |
| Potassium mg | 4700 | 1880 | 411.00 | 358.00 | 184.00 | 953 | 51% | 51% |
| Sodium mg | 2300 | 920 | 2400.00 | 1.00 | 0.00 | 2401 | 261% | 100% |
| Zinc mg | 11 | 4.4 | 13.39 | 0.15 | 0.06 | 13.6 | 309% | 100% |
| Copper mg | 900 | 360 | 0.25 | 0.08 | 0.05 | 0.378 | 0% | 0% |
| Selenium ug | 55 | 22 | 23.50 | 1.00 | 1.00 | 25.5 | 116% | 100% |
| Score | | | | | | | 170.27% | 79.66% |

Requirements for Lunch and Dinner

Nutritional Requirements for lunch are calculated in a similar fashion but would include the ‘deficits’ or ‘surpluses’ from breakfast. Note absolute values are used for calculations, but for the purposes of information presentation/visualization of the GorMonjee Score, the normalized values are used. It is unclear what form of visualization would be best for dinner in the event that the deficits of the day or time period in question resulted in a GorMonjee Score/Requirement for the meal in question to be above 100% as it would be if one were to consume a particularly nutrient poor meal in the same time period. Similarly, absolute values would be used for food suggestion. The complicated nature of these calculations hence requires a computer/program to run various matching scenarios to result in the ‘best’ food suggestion.

Visualization of the GorMonjee Score using the RGB Colour Scheme

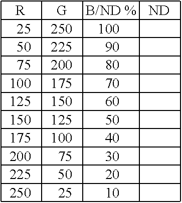

The above configuration results in ‘good food’ resulting in a Green Energy Meter, and ‘bad food’ resulting in a ‘Red Energy Meter’.

Customized Interventions which Remind Users to Avoid Eating Certain Types of Food Based on Location, Health History and Food Preferences
1. Interventions & graphical representation of Monjee/iMonjee state/health status based on Nutritional Input
   a. Total Calories per day
   b. Number of meals
   c. proportion of calories per meal
   d. macronutrient proportions
      i. fat, carbs, proteins, fiber, water
   e. Ability to select to dietary modules
      i. diabetic, gluten intolerant, vegetarian etc. . . .
      ii. average caloric diet
      iii. average nutritional requirements
      iv. any specific diet created for anyone with a specific disease state
2. Interventions & graphical representation of Monjee/iMonjee state/health status based on Energy Expenditure
   a. ability to enter exercises and time spent exercising
   b. ability to use the motion sensing/gyroscope/to record activity/movement and infer
   c. ability to enter average energy expenditure based on lifestyle
      i. sedentary, active etc. . . .
   d. ability to infer energy expenditure and relate to avatar/Monjee/iMonjee movement across screen inferring rise/fall in energy

Goal-Oriented Tool in the Form of a ‘Virtual Avatar’—(Monjee/iMonjee)-which Responds by Changes to its Appearance, Energy Level Etc. . . . to Food Eaten by the User
i. Creation of iMonjee
   1. Take a picture of self
   2. select head/pinch to zoom head like outline
   3. choose cartoon body type
   4. position head on body
   5. click done
   6. creation complete
   7. iMonjee has ability to move/change looks based on energy levels (good meal, full=energetic avatar; skipped meals=lethargicisad avatar)
ii. iMonjee manipulation
   1. pinch to zoom to increase weight
   2. pinch to zoom to increase height
   3. numerical representation of weight and height during pinch to zoom actions
   4. long click to enter imonjee/mymonjee settings from home screen
iii. Settings
   1. ability to change iMonjee features
      a. face, body size, gender, clothes, head gear etc. . . .
Envisioned mode of information entry/How can one enter information into the app?
iv. Through drop down menus
v. Through bar code scanning
vi. through taking pictures of objects/barcodes/nutritional labels/text/other OCR type software/apps such as evernote/google goggles
vii. voice input/text input
viii. by choosing pictures/graphics representing food/drinks/edible items/plants/animals
ix. #ref by getting input from RFID tags/NFC tags/other Radio Frequency micro circuits capable of transmitting and receiving data/flexible wearable electronics
x. web operations can data mine and push information to the web/mobile app
xi. use a website for the above
xii. use a standalone scanning device linked to a refrigerator or other food storage or food preparing mechanical or electrical device
xiii. using any combination of the above
xiv. using #refA with a combination of food carts/shopping carts/shopping bags/other storage areas/trunk of a car
xv. information related to mood/psychological state in the form of common memes such as emoticons
xvi. by virtue of #backend
Ability to connect to other health monitoring devices (scale, bp etc) to create interventions
Link to fitbit, & similar softwares

A subscription based model can also be created where value added features would attract users to pay for the app. Such features could include a greater ability to customize the Monjee/iMonjee and the web-based application itself. Other embodiments involve social network based public sharing of eating habits, virtual avatar based games (revolving around food choices), digital capture of barcode, NFC tag, RFID information, as well as, taking pictures of food eaten to record what food is being eaten.

Some unique features of the service/product are as follows: User Interface—An avatar is envisioned which can act as the primary user interface—the Avatar responds to the user's dietary choices by virtually ‘eating’ a graphic of the food choice of what the user eats in the ‘real world’. The avatar's appearance and feedback can be dynamic and dependent on the user's real world choices. Energy Meter—An energy meter can be calculated based on the nutrient density of the required food to be consumed by the user and will visually calibrate potential food choices/options—as the energy bar continues to fill by virtue of good food choices, the Avatar becomes active and rises in ‘energy’. Poor food choices result in a lethargic avatar and in some cases may even result in an overweight avatar.
i. iMonjee movement across the screen or home page: according to any medication or drug, vitamins, food supplement

a. What can the GorMonjee information be used for?
i. #refB GorMonjee Score—creation of the gormonjee score (numerical as well as graphical in the form such as an energy bar where specific colors—represented by either machine or human language—indicate specific scores and specific states about energy or states of the virtual avatar or iMonjee or states of health. The GorMonjee score will be partially calculated by the created nutrient density equation (see calculation of score above)
   1. used for making food suggestions drink suggestions/grocery lists
   2. suggestions based on desired user variables such as
      a. macronutrient ratio
      b. micronutrient preference
      c. food type/ingredient
      d. price points
      e. price per nutrient
      f. geolocation
      g. past preferences
      h. ability to create custom preferences
      i. blood chemistry of protein levels
      j. Blood chemistry of biomarkers associated with nutrition
   3. used for tracking food ingestion
   4. used for the creation of customized lists such as my pantry/home recipes/
   5. used for potentially representing effect on energy levels gormonjee score and nutritional balances/indices for prospective food choices
   6. calculation of the micro nutrient density score
   7. calculation of the macro nutrient density score
   8. calculation of a GorMonjee vitamin score
ii. #refC Graphical representation of #refB
   1. #refE in the form of line/bar/pie/scatter other statistical graphical representations/charts
      a. placing #refE next to iMonjee on Home Screen/Settings
   2. ability to pinch/zoom to narrow into smaller granulation of time and vice versa
   3. ability to display multiple forms of information in #refB simultanesouly
   4. ability to create custom indicators/ratios using #refB
iii. Ability to do #refB and #refC on any digital device with a screen—kinda broad #refD
iv. Ability to create and order from the GorMonjee store custom beverages based on food ingestion history
v. ability to use app to generate grocery list and then order food from online portals/web stores/websites
vi. #backend ability to send grocery list/messages by selecting graphical representations of food items/drinks/ingredients or the a ‘buy’ button to a web server to link with other third party servers for the purposes of conducting e commerce functions such as pre ordering groceries for pick up or delivery and or purchasing selected items through either online or physical locations.

This goal oriented approach encourages healthy eating and will be result in ‘points’ being awarded. These ‘points’ will translate into real world ‘prizes’ such as free music, badges on social networks, offers that contribute to healthy life choices, etc. . . . thereby completing a real world to virtual world to real world loop. It is envisioned that this loop will provide incremental monetization avenues.
i. Ability to link to friends/social media—ability to represent user on social network and other games using iMonjee/Monjee/virtual avatar
ii. Ability to see those in your circles/create customized friend or contact list with different levels of access to personal information
   1. ability to ascertain what friends are eating and ability to suggest which foods to eat by your friends/contacts/other GorMonjee users.
   2. ability to compete, in customized, games, online, using iMonjee's/
   3. monjee's or virtual avatars based on geolocation or energy meter or GorMonjee scores (gamification)
iii. Ability to see and compare energy levels and other customized indicators from other GorMonjee users and the ability to create custom indicators from the same.
iv. Ability to create incentives/points/‘winning’ and then to link advertising or billing revenue and other ecommerce activities based on the same
v. Able to ‘earn’ medals which provide you more options for your avatar (clothes, hats, accessories)

The web-based application can suggest healthy eating options. Healthy options are those foods which satisfy the complete nutritional requirements of the human body in terms of Macro and Micronutrients and result in satiety from those choices. Embodiments involve recording what one eats in the morning, suggests which eating options are available, suggests which foods to buy from which grocery store based on the deficits or surpluses of health eating during the day/week. If the user has been eating very healthy food, the app will suggest/allow the user to eat those foods that may not particularly ‘nutritious’ and vice versa.

Since the web-based application can be targeted at young working adults it can be designed for individuals who don't want to count calories and want to eat out (lunch and/or dinner), the web-based application can recognize the food that is being eaten and hence can suggest foods that will make up any nutrient deficits that occur.

The web-based application can easily assimilate data and provide easy information entry currently lacking in substantially all convention nutrition monitoring apps. It can also enable users to be free from fixed dietary regimens that demand that all food be bought from single vendor.

### Example Advertising Content Archiving and Billing Postponement

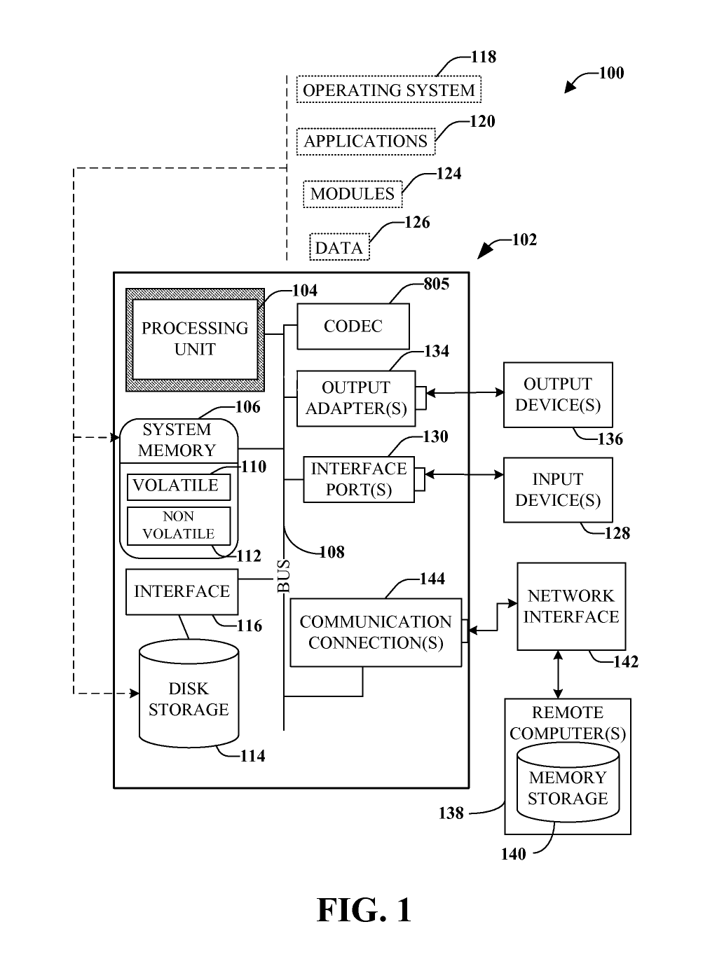

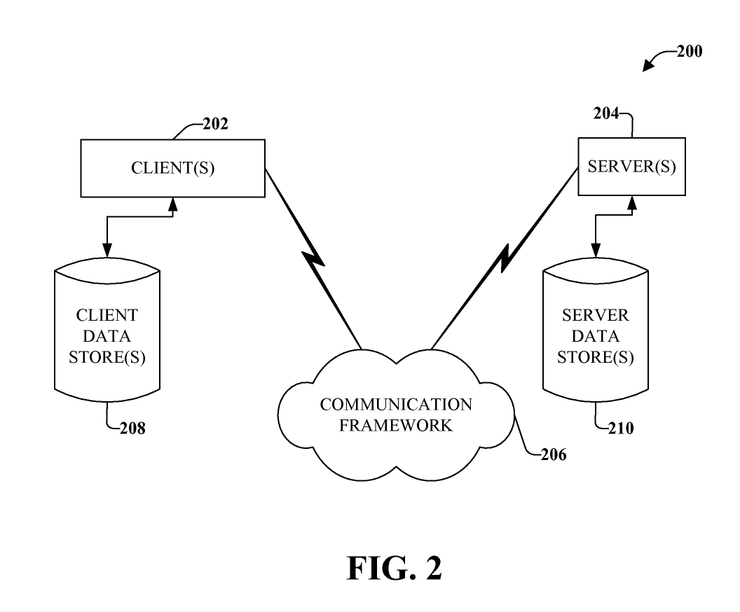

Aspects of the systems, apparatuses or processes explained in this disclosure can constitute machine-executable component(s) embodied within machine(s), e.g., embodied in one or more computer readable mediums (or media) associated with one or more machines, non-limiting examples of which are illustrated in relation to FIGS. 1 and 2. Such component, when executed by the one or more machines, e.g., computer(s), computing device(s), virtual machine(s), etc. can cause the machine(s) to perform the operations described.

A client device can include any suitable computing device associated with a user and configured to interact with or receive media content. For example, a client device can include a mobile device, a mobile phone, personal data assistant, laptop computer, tablet computer, desktop computer, server system, cable set top box, satellite set top box, cable modem, television set, media extender device, blu-ray device, DVD (digital versatile disc or digital video disc) device, compact disc device, video game system, audio/video receiver, radio device, portable music player, navigation system, car stereo, etc. Moreover, a client device can include a user interface (e.g., a web browser or application), that can receive and present displays and generated locally or remotely.

As used in this disclosure, the terms “content consumer” or “user” refer to a person, entity, system, or combination thereof. In an aspect, a client device can be configured to access media content via a wired or wireless network, such as for example the Internet, intranet, or cellular service.

In order to provide for or aid in the numerous inferences described in this disclosure, components can examine the entirety or a subset of data to which it is granted access and can provide for reasoning about or inferring relevancy to and desirability of viewing respective content sections by respective content consumers. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events or data.

Such inference can result in construction of new events or actions from a set of observed events or stored event data, whether or not the events are correlated in close temporal proximity, and whether the events and data come from one or several event and data sources. Various classification (explicitly or implicitly trained) schemes or systems (e.g., support vector machines, neural networks, expert systems, Bayesian belief networks, fuzzy logic, data fusion engines, etc.) can be employed in connection with performing automatic or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used in this disclosure also is inclusive of statistical regression that is utilized to develop models of priority.

While, for purposes of simplicity of explanation, the methodologies described herein as a series of acts, the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be appreciated that the methodologies disclosed in this disclosure are capable of being stored on an article of manufacture to facilitate transporting and transferring such methodologies to computers or other computing devices.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be effected across a plurality of devices. Accordingly, the invention is not to be limited to any single embodiment, but rather can be construed in breadth, spirit and scope in accordance with the appended claims.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

With reference to FIG. 1, a suitable environment 100 for implementing various aspects of the claimed subject matter includes a computer 102. The computer 102 includes a processing unit 104, a system memory 106, a codec 105, and a system bus 108. In an embodiment, the computer 102 can for example be used to implement one or more of the systems or components shown or described in connection with FIGS. 1-4. The system bus 108 couples system components including, but not limited to, the system memory 106 to the processing unit 104. The processing unit 104 can be any of various available processors. Dual microprocessors and other multiprocessor architectures also can be employed as the processing unit 104.

The system bus 108 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 106 includes volatile memory 110 and non-volatile memory 112. The basic input/output system (BIOS), containing the basic routines to transfer information between elements within the computer 102, such as during start-up, is stored in non-volatile memory 112. In addition, according to present innovations, codec 105 may include at least one of an encoder or decoder, wherein the at least one of an encoder or decoder may consist of hardware, a combination of hardware and software, or software. Although, codec 105 is depicted as a separate component, codec 105 may be contained within non-volatile memory 112. By way of illustration, and not limitation, non-volatile memory 112 can include read only memory (ROM), programmable ROM (PROM), electrically programmable ROM (EPROM), electrically erasable programmable ROM (EEPROM), or flash memory. Volatile memory 110 includes random access memory (RAM), which acts as external cache memory. According to present aspects, the volatile memory may store the write operation retry logic (not shown in FIG. 1) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 102 may also include removable/non-removable, volatile/non-volatile computer storage medium. FIG. 1 illustrates, for example, disk storage 114. Disk storage 114 includes, but is not limited to, devices like a magnetic disk drive, solid state disk (SSD) floppy disk drive, tape drive, Jaz drive, Zip drive, LS-70 drive, flash memory card, or memory stick. In addition, disk storage 114 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 114 to the system bus 108, a removable or non-removable interface is typically used, such as interface 116.

It is to be appreciated that FIG. 1 describes software that acts as an intermediary between users and the basic computer resources described in the suitable operating environment 100. Such software includes an operating system 118. Operating system 118, which can be stored on disk storage 114, acts to control and allocate resources of the computer system 102. Applications 120 take advantage of the management of resources by operating system 118 through program modules 124, and program data 126, such as the boot/shutdown transaction table and the like, stored either in system memory 106 or on disk storage 114. It is to be appreciated that the claimed subject matter can be implemented with various operating systems or combinations of operating systems.

A user enters commands or information into the computer 102 through input device(s) 128. Input devices 128 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 104 through the system bus 108 via interface port(s) 130. Interface port(s) 130 include, for example, a serial port, a parallel port, a game port, and a universal serial bus (USB). Output device(s) 136 use some of the same type of ports as input device(s) 128. Thus, for example, a USB port may be used to provide input to computer 102, and to output information from computer 102 to an output device 136. Output adapter 134 is provided to illustrate that there are some output devices 136 like monitors, speakers, and printers, among other output devices 136, which require special adapters. The output adapters 134 include, by way of illustration and not limitation, video and sound cards that provide a means of connection between the output device 136 and the system bus 108. It should be noted that other devices and/or systems of devices provide both input and output capabilities such as remote computer(s) 138.

Computer 102 can operate in a networked environment using logical connections to one or more remote computers, such as remote computer(s) 138. The remote computer(s) 138 can be a personal computer, a server, a router, a network PC, a workstation, a microprocessor based appliance, a peer device, a smart phone, a tablet, or other network node, and typically includes many of the elements described relative to computer 102. For purposes of brevity, only a memory storage device 140 is illustrated with remote computer(s) 138. Remote computer(s) 138 is logically connected to computer 102 through a network interface 142 and then connected via communication connection(s) 144. Network interface 142 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 144 refers to the hardware/software employed to connect the network interface 142 to the bus 108. While communication connection 144 is shown for illustrative clarity inside computer 102, it can also be external to computer 102. The hardware/software necessary for connection to the network interface 142 includes, for exemplary purposes only, internal and external technologies such as, modems including regular telephone grade modems, cable modems and DSL modems, ISDN adapters, and wired and wireless Ethernet cards, hubs, and routers.

Referring now to FIG. 2, there is illustrated a schematic block diagram of a computing environment 200 in accordance with this disclosure. The system 200 includes one or more client(s) 202 (e.g., laptops, smart phones, PDAs, media players, computers, portable electronic devices, tablets, and the like). The client(s) 202 can be hardware and/or software (e.g., threads, processes, computing devices). The system 200 also includes one or more server(s) 204. The server(s) 204 can also be hardware or hardware in combination with software (e.g., threads, processes, computing devices). The servers 204 can house threads to perform transformations by employing aspects of this disclosure, for example. One possible communication between a client 202 and a server 204 can be in the form of a data packet transmitted between two or more computer processes wherein the data packet may include video data. The data packet can include metadata, e.g., associated contextual information, for example. The system 200 includes a communication framework 206 (e.g., a global communication network such as the Internet, or mobile network(s)) that can be employed to facilitate communications between the client(s) 202 and the server(s) 204.

Communications can be facilitated via a wired (including optical fiber) and/or wireless technology. The client(s) 202 include or are operatively connected to one or more client data store(s) 208 that can be employed to store information local to the client(s) 202 (e.g., associated contextual information). Similarly, the server(s) 204 are operatively include or are operatively connected to one or more server data store(s) 210 that can be employed to store information local to the servers 204.

In one embodiment, a client 202 can transfer an encoded file, in accordance with the disclosed subject matter, to server 204. Server 204 can store the file, decode the file, or transmit the file to another client 202. It is to be appreciated, that a client 202 can also transfer uncompressed file to a server 204 and server 204 can compress the file in accordance with the disclosed subject matter. Likewise, server 204 can encode video information and transmit the information via communication framework 206 to one or more clients 202.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A system, comprising:
a processor configured to execute computer executable instructions stored in a memory to perform the following acts:
identifying state information of a user; and
suggesting personalized food choices based on the user's dietary history at point of purchase or point of decision making to encourage healthy food choices.

2. The system of claim 1, the acts further comprising receiving or transmitting location-based contextual information regarding food choices based on customized dietary constraints and food preferences.

3. The system of claim 1, the acts further comprising generating nutritional indices providing a single data point with which to decipher nutritional information.

4. The system of claim 3, the acts further comprising geographically circumscribing the nutritional information, and presenting the geographically circumscribed nutritional information to the user.

5. The system of claim 1, the acts further comprising generating customized interventions which remind users to avoid eating certain types of food based on location, health history and food preferences.

6. The system of claim 1, the acts further comprising generating and causing to be displayed a goal-oriented tool in the form of a virtual avatar which responds by changes to its appearance or energy level corresponding to food eaten by the user.

7. The system of claim 6, the acts further comprising the avatar responding to the user's dietary choices by virtually ‘eating’ a graphic of a food choice of what the user ate in the ‘real world’.

8. A method, comprising:
using a processor to execute computer executable instructions stored in a memory to perform the following acts:
identifying state information of a user; and
suggesting personalized food choices based on the user's dietary history at point of purchase or point of decision making to encourage healthy food choices.

9. The method of claim 8, further comprising receiving or transmitting location-based contextual information regarding food choices based on customized dietary constraints and food preferences.

10. The method of claim 8, further comprising generating nutritional indices providing a single data point with which to decipher nutritional information.

12. The method of claim 10, further comprising geographically circumscribing the nutritional information, and presenting the geographically circumscribed nutritional information to the user.

13. The method of claim 8, further comprising generating customized interventions which remind users to avoid eating certain types of food based on location, health history and food preferences.

14. The method of claim 8, further comprising generating and causing to be displayed a goal-oriented tool in the form of a virtual avatar which responds by changes to its appearance or energy level corresponding to food eaten by the user, and displaying avatar movement, based in part on at least one of: food eaten; energy expenditure; lapse in time; activities; energy or state of health; eating healthy food; or food with a high score.

15. The method of claim 13, wherein the avatar responds to the user's dietary choices by virtually ‘eating’ a graphic of a food choice of what the user ate in the ‘real world’.

16. A system, comprising:
means for identifying state information of a user; and
means for suggesting personalized food choices based on the user's dietary history at point of purchase or point of decision making to encourage healthy food choices.

17. The system of claim 16, further comprising means for receiving or transmitting location-based contextual information regarding food choices based on customized dietary constraints and food preferences.

18. The system of claim 16, further comprising means for generating nutritional indices providing a single data point with which to decipher nutritional information.

19. The system of claim 18, further comprising means for geographically circumscribing the nutritional information, and presenting the geographically circumscribed nutritional information to the user.

20. The system of claim 16, further comprising means for generating customized interventions which remind users to avoid eating certain types of food based on location, health history and food preferences.

21. The system of claim 16, further comprising means for generating and causing to be displayed a goal-oriented tool in the form of a virtual avatar which responds by changes to its appearance or energy level corresponding to food eaten by the user.

22. The system of claim 21, wherein the avatar responds to the user's dietary choices by virtually ‘eating’ a graphic of a food choice of what the user ate in the ‘real world’.
